(19) United States
(12) Patent Application Publication
(10) Pub. No.: US 2008/0235773 A1
(43) Pub. Date: Sep. 25, 2008

(54) Method of irrugalar password configuration and verification

(75) Inventor: Hou-Cheng Chen, Hsichih (TW)

Correspondence Address: BRUCE H. TROXELL, SUITE 1404, 5205 LEESBURG PIKE, FALL SCHURCH, VA, 22041, US

(73) Assignee: WISTRON CORP.

(21) Appl. No.: 11/802,240

(22) Filed: May 21, 2007

(30) Foreign Application Priority Data
Mar. 22, 2007 (TW) 096110004

(51) Int. Cl. H04L 9/32

(52) U.S. Cl. 726/6

(57) ABSTRACT

A method of irregular password configuration and verification, comprising one irregular character series with a series of texts, numbers or symbols inputted into a system to generate a series of password displaying onscreen of a display device. The series of password comprises at least one register code and at least one random combination unit with a text and a number, or a symbol, wherein the register code is concealed in the random combination unit.

### BACKGROUND OF THE INVENTION

1. Field of the Invention

This invention relates to a method of password configuration and verification for authenticating user's identity, and more particularly, to a method of password configuration and verification for the user login a network system.

2. Description of Related Art

People have to memorize a lot of various passwords to login the different application or operation systems. However, with more and more complicated password generation rules, one simple password with “1234” or “abcd” is not accepted by many operation systems nowadays. Also, it is annoying to follow the rule of password generation; for instance, it always drives people crazy to series a password that complied with IBM CMVC system. Moreover, the password for logon the Internet requires texts, numbers and specific symbols and even the password can not be a sequential of numbers or alphabetic texts, within the numbers have to be set between the alphabetic texts.

In addition, there are the prior arts relating to the dynamic password generation. For example, one is TW Publication No. 200605600 titled in “PORTABLE APPARATUS GENERATING ONE-TIME PASSWORD METHOD AND SYSTEM THEREOF” disclosing a one-time password (OTP) generating chip, hardware or firmware installed in a portable apparatus, such as a PDA or cell phone, portable computer or other mobile electronic devices, of a user to generate a dynamic password and an OTP. Then, user can use the OTP to logon a system for passing the authentication. The other is TW Publication No. 200537889 which discloses a method and a system for transferring a dynamic password comprising the steps of accessing the identify code in a chip card via a terminal; transferring the identity code to a remote server; searching an address code corresponding to the identity code; generating a dynamic password connecting to the address code; transferring the dynamic password to a mobile device, and finally a user can input the dynamic password to the terminal for verifying the dynamic password. If the dynamic password is correct, the user can successfully access in a system; whereas, the dynamic password can not be accepted and the deal will be terminated.

Bearing in mind the problems and deficiencies of the prior art, it is therefore an object of the present invention to provide a method for configuring and verifying irregular password.

It is an other object of the present invention to provide a method of irregular password configuration and verification for a user to access in a system via a series of password, and then others can not reuse the same password to access in the system.

It is a further object of the present invention to provide a method of irregular password configuration and verification for a user to access in applicable systems with different password sets followed by the principle of password generation.

Still other objects and advantages of the invention will in part be obvious and will in part be apparent from the specification.

### SUMMARY OF THE INVENTION

The above and other objects and advantages, which will be apparent to one of skill in the art, are achieved in the present invention which is directed to, in a first aspect, a method of irregular password configuration to login an operation system by setting a series of password comprises the steps: inputting one irregular character set grouped by a series of texts, numbers, symbols or one combination grouped by a series of various characters to a system; generating one set of password after inputting one irregular character set displaying on screen of a display device; wherein the series of password including at least one register code and at least one combination unit to being a series of irregular password which respectively includes at least a character which either is a text, a number, a symbol or one combination grouped by various characters, wherein the combination unit comprising one random character.

In an other aspect of the present invention, a method for verifying irregular password comprises the steps: verifying an input with at least one combination unit whether including at least a register code by the examination of the operation system, wherein the combination unit comprising at least one random character which either is a text, a number, a symbol or one combination grouped by various characters; verifying whether the register code existing within the input. If the register code exists, the input is authenticated as one valid password; whereas, if the register code not existing, the input is authenticated as one invalid password.

In yet an other aspect of the present invention, a method of irregular password verification comprises the steps: verifying an input with at least one combination unit whether including at least one series of register codes by the examination of the operation system, wherein the series of register codes comprising at least an initial code and an ending code, and wherein the combination unit comprises at least one random character which either is a text, a number; a symbol or one combination grouped by various characters; verifying whether the ending code exists within the input if the initial code existing within the input; whereas, the input being authenticated as an invalid password if the initial code not existing within the input; authenticating the input as a series of valid password if the ending code existing within the input by the examination of operation system; whereas, the input being authenticated as a series of invalid password if the ending code not existing within the input.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a demonstration of irregular password configuration according to the present invention.

FIG. 2 is a flowchart diagram of a sequence for the first preferred embodiment of irregular password verification according to the present invention.

FIG. 3 is a flowchart diagram of a sequence for the second preferred embodiment of irregular password verification according to the present invention.

FIG. 4 is a flowchart diagram of a sequence for the third preferred embodiment of irregular password verification according to the present invention.

FIG. 5 is a flowchart diagram of a sequence for the fourth preferred embodiment of irregular password verification according to the present invention.

FIG. 6 is a flowchart diagram of a sequence for the fifth preferred embodiment of irregular password verification according to the present invention.

### DETAILED DESCRIPTION OF THE INVENTION

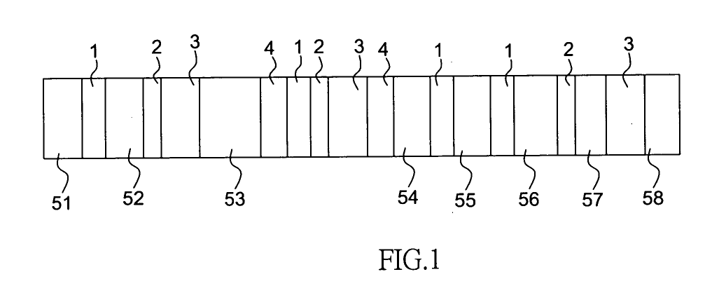

Referring to FIG. 1, the demonstration of irregular password configuration according to the present invention illustrates a method of irregular password configuration by setting a series of password to login various operation systems of a computer, an ATM machine of banking system, a webpage of remote server for the Internet or a mainframe of wireless communication network.

The present invention relates to a method of irregular password configuration to login a system by setting a series of password, comprising the steps: inputting one irregular character set grouped by a series of texts, numbers, symbols or one combination grouped by a series of various characters into a system, such as a mainframe, mobile communication device and so on; generating a series of password displaying on screen of a display device; wherein the series of password including at least one register code and at least one combination unit 51-58 which respectively includes at least a character either a text, a number, a symbol or one combination grouped by various character. Further, the register code either comprises an initial code 1, an intermediate code 2 and an ending code 3, or comprises only an initial code 1 and an ending code 3, wherein the series of register codes includes one combination unit arranged among the initial code 1, the intermediate code 2 and the ending code 3. On the other hand, the present invention further comprises at least a cancel code 4. The aforementioned initial code 1, the intermediate code 2, ending code 3 and cancel code 4 respectively includes at least a character. In addition, the present invention further comprises one random combination unit 51-58 to generate a series of irregular password. Referring to FIG. 1, the combination unit 51 and 58 respectively is series at the front and end of the series of the password. Also, the combination unit 52-57 is set within the initial code 1, the intermediate code 2, the ending code 3 and the cancel code 4, wherein the series of the password comprises at least one register code or a series of register code in which the cancel code 4 does not exist. Further, the cancel code 4 does not exist behind either the register code or the series of register codes closest to the end of the series of the password. In FIG. 1, the initial code 1 behind the second cancel code 4, the combination unit 56, the intermediate code 2, the combination unit 57 and the ending code 3 behind the second cancel code 4 are grouped as a series of register codes. Therefore, the series of password including the initial code 1, the intermediate code 2, the ending code 3, the cancel code 4 and the random combination units 51-58 which will dramatically increase the difficulties of password fraud.

Followed by the aforementioned password generation rule, assuming the initial code as “1”, the intermediate code as “9453”, the ending code as “63”, and the cancel code as “25” and inputting a series of texts, numbers, or symbols into a system and then the system will generate a series of password as follows, “34527@$%$7638327̂0df2sd9453f245&345148*!!@0894533633254652294537856313457208s2fljlj945335494537s2s5f63111579 32273945357566386”.

According to the aforementioned series, once the first cancel code “25”, appearing behind the initial code “1”, intermediate code “9453” and the ending code “63”, is inputted, the series is identified to being a series of unenforceable password. On the other hand, after the appearance of the first cancel code “25”, the other codes are sequentially inputted, including the initial code “1”, intermediate code “9453’ and ending code “63”, and then the hole series are grouped as a series of register codes; further, if the cancel code “25” does not appears behind the final ending code “63”, the series is identified to being a series of enforceable password. User can input different combination unit grouped by random characters among the initial code “1”, the intermediate code “9453” and the ending code “63” to minimize the opportunities of the series of password being cracked. Particularly, with the feature of inputting the cancel code “25”, user can randomly control whether to input the register code or the series of register codes which strengthens the difficulty of password being cracked. By utilizing the aforementioned password generation rule presented in the present invention, user can friendly manipulate a series of irregular password in a variety of systems which have the functionality of verifying the irregular password; further, user do not need to specifically memorize any password for various systems.

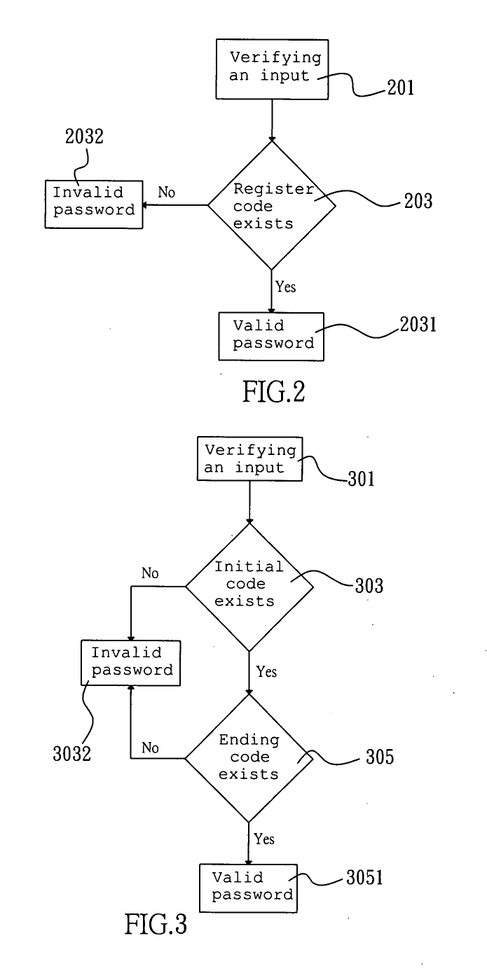

Referring to FIG. 2, the flowchart diagram of a sequence for the first preferred embodiment of irregular password verification according to the present invention comprises the steps:

Step 201: Verifying an input with at least one combination unit whether including at least a register code by the examination of the operation system, wherein the combination unit comprises at least one random character which either is a text, a number, a symbol or one combination grouped by various characters.

Step 203: Verifying the register code whether existing within the input. If the register code exists, the input is authenticated as one valid password (2031); whereas, if the register code does not exist, the input is authenticated as one series of invalid password (2032). Referring to FIG. 3, the flowchart diagram of a sequence for the second preferred embodiment of irregular password verification according to the present invention comprises the steps:

Step 301: Verifying an input with at least one combination unit whether including at least a series of register codes by the examination of the operation system, wherein the series of register codes includes an initial code and an ending code; the combination unit comprises at least one random character which either is a text, a number, a symbol or one combination grouped by various characters.

Step 303: If the initial code exists within the input, the input is continuously examined whether the ending code exists; whereas, if the initial code does not exist within the input, the input is authenticated as one series of invalid password (3032).

Step 305: If the ending code exists within the input, the input is authenticated as one series of valid password (3051) by the examination of operation system; whereas, if the ending code does not exit within the input, the input is authenticated as one series of invalid password (3031).

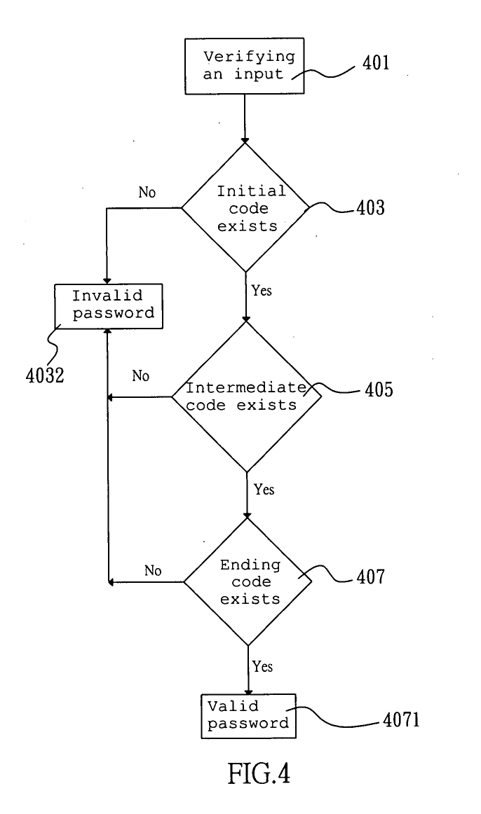

Referring to FIG. 4, the flowchart diagram of a sequence for the third preferred embodiment of irregular password verification according to the present invention comprises the steps:

Step 401: Verifying an input with at least one combination unit whether including at least a series of register codes by the examination of the operation system, wherein the series of register codes comprises at least an initial code, an intermediate code and an ending code, wherein the combination unit comprises at least one random character which either is a text, a number, a symbol or one combination grouped by various characters.

Step 403: If the initial code exists within the input, continuously examining the intermediate code whether exists within the input; whereas, if the initial code does not exist, the input is authenticated as a series of invalid password (4032) by the examination of operation system.

Step 405: If the intermediate code exists within the input, continuously examining whether the ending code exists within the input; whereas, if the intermediate code does not exist, the input is authenticated as a series of invalid password (4032)

Step 407: If the ending exists within the input, the input is authenticated as a series of valid password (4071); whereas, if the ending code does not exist within the input, the input is authenticated as a series of invalid password (4032).

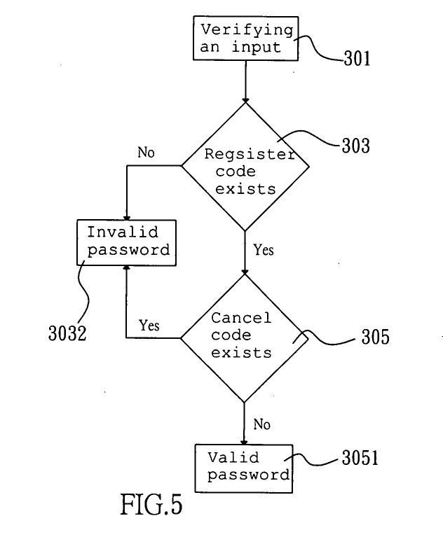

Referring to FIG. 5, the flowchart diagram of a sequence for the fourth preferred embodiment of irregular password verification according to the present invention comprises the steps:

Step 501: Verifying an input with at least one combination unit whether including at least a register code and a cancel code by the examination of the operation system, wherein the combination unit comprises at least one random character which either is a text, a number, a symbol or one combination grouped by various characters.

Step 503: If the register code exists within the input, continuously examining whether a cancel code exists behind the end of the register code, which is closest to the end of the input; whereas, if the register code does not exist within the input, the input is authenticated as one series of invalid password by the examination of operation system (5032);

Step 505: If the cancel code exists, the input is authenticated as a series of invalid password (5032) by the examination of operation system; whereas, if the cancel code does not exist, the input is authenticated as a series of valid password (5051).

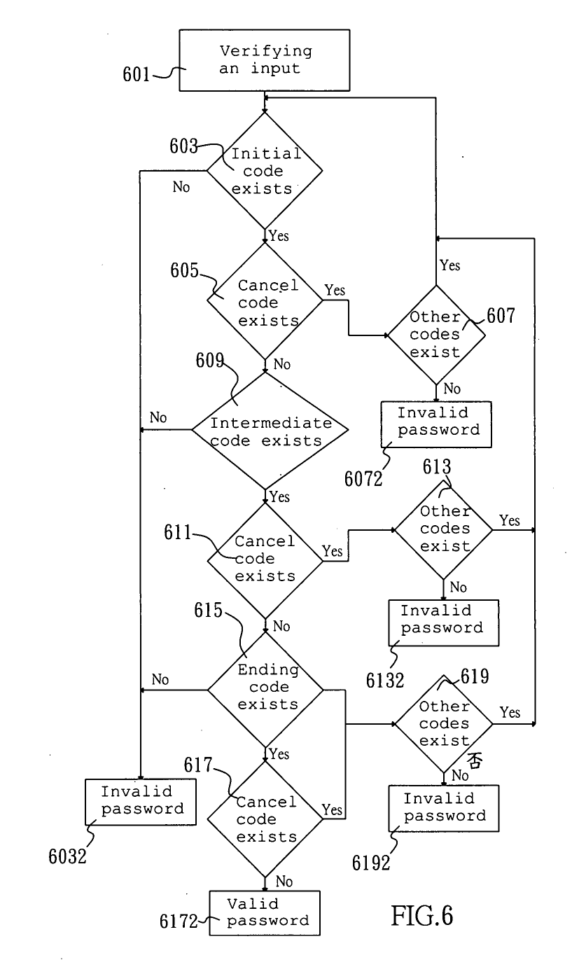

Referring to FIG. 6, the flowchart diagram of a sequence for the fifth preferred embodiment of irregular password verification according to the present invention, comprises the steps:

Step 601: Verifying an input with at least one combination unit which includes at least a series of register codes and at least a cancel code, wherein the series of register codes includes an initial code, an intermediate code and an ending code, wherein the combination unit includes at least one random character which either is a text, a number, a symbol or one combination grouped by various characters.

Step 603: If the initial code exists within the input, continuously examining whether a cancel code exists; whereas, if the initial code does not exist, the input is authenticated as a series of invalid password (6032) by the examination of operation system.

Step 605: If the cancel code exists within the input, continuously verify whether other codes exist behind the cancel code; whereas, if the cancel code does not exist within the input, continuously examining whether an intermediate code exists within the input by the examination of operation system.

Step 607: If other codes exist behind the cancel code, continuously verifying the input whether an initial code exists; whereas, if there are not other codes existing behind the cancel code, the input is authenticated as a series of invalid password (6072) by the examination of operation system.

Step 609: If the intermediate code exists within the input, continuously examining the input whether the cancel code exists; whereas, if the intermediate code does not exist, the input is authenticated as a series of invalid password (6032) by the examination of operation system.

Step 611: If the cancel code exist within the input, continuously verifying whether other codes exist behind the cancel code; whereas, if the cancel code does not exist, continuously examining the input whether the ending code exists.

Step 613: If other codes exist behind the cancel code, continuously examining the input whether the initial code exists; whereas, if there are not other codes behind the cancel code, the input is authenticated as a series of invalid password (6132) by the examination of operation system.

Step 615: If the ending code exists within the input, continuously examining the input whether the cancel code exists; whereas, if the ending code does not exist within the input, the input is authenticated as a series of invalid password (6032) by the examination of operation system.

Step 617: If the cancel code exists within the input, continuously examining whether other codes exist behind the cancel code; whereas, if the cancel code does not exist within the input, the input is authenticated as a series of valid password (6172) by the examination of operation system.

Step 619: If other codes exist behind the cancel code, continuously examining the input whether the initial code exists; whereas, if there are not other codes behind the cancel code, the input is authenticated as a series of invalid password (6192) by the examination of operation system.

The present invention relates to a method of irregular password configuration and verification comprising an initial code, an intermediate code, and an ending code; further, comprises one irregular character set with a series of texts, numbers, symbols inputting into a system to generate a series of password. The series of password comprises at least a register code or a series of register codes and at least one random combination unit with at least a text, a number, or a symbol, wherein either the register code or the series of register codes is concealed in the random combination unit.

The present invention relates to a method of irregular password verification further comprises similarly authenticated procedure in a system. When user input the same inputs or similar inputs in a system, the system identifies these inputs as invalid inputs. Therefore, these used inputs can not be reused by others. However, user can designate a plurality of one-time-use password sets to avoid password cracked. Meanwhile, user only needs to follow the password generation rule to create a plurality of password series without memorizing numerous password series.

While the present invention has been particularly described, in conjunction with a specific preferred embodiment, it is evident that many alternatives, modifications and variations will be apparent to those skilled in the art in light of foregoing description. It is therefore contemplated that the appended claims will embrace any such alternatives, modifications and variations as falling within the true scope and spirit of the present invention.

What is claimed is:

1. A method for configuring irregular password, employed by a user to set a series of password to logon an operation system, comprising the following steps:
inputting one irregular character set grouped by a series of texts, numbers, symbols or one combination grouped by a series of various characters into a system;
generating a series of password after inputting one irregular character set displaying on screen of a display device;
wherein the series of password includes at least a register code and at least a combination unit to being a series of irregular password which respectively includes at least a character which is a text, a number, or a symbol;
wherein the combination unit comprises one random character; whereby the operation system verifies an input whether includes the register code and further to verify the input whether is an irregular password.

2. The method of claim 1, wherein the series of password further comprises at least a cancel code, wherein the cancel code does not exist behind the end of the register code closest to the end of the series of password.

3. The method of claim 2, wherein the register code comprises an initial code and an ending code which respectively includes at least one character; wherein the initial code and the ending code are arranged in order.

4. The method of claim 3, wherein the initial code, the ending code and the combination unit are grouped as a series of register codes without including the cancel code, wherein the combination unit is arranged between the initial code and the ending code.

5. The method of claim 3, wherein the register code further comprises an intermediate code; the intermediate code including at least one character; the intermediate code is arranged between the initial code and the ending code.

6. The method of claim 5, wherein the initial code, the intermediate code and the combination unit are grouped as a series of register codes without including the cancel code, wherein the combination unit is arranged between the initial code and the intermediate code.

7. The method of claim 6, wherein the combination unit is arranged between the intermediate code and the ending code.

8. The method of claim 1, wherein the register code comprises an initial code and an ending code which respectively comprises at least one character, and wherein the initial code and the ending code are arranged in order.

9. The method of claim 8, wherein the initial code, the ending code and the combination unit are grouped as a series of register codes, wherein the combination unit is arranged between the initial code and the ending code.

10. The method of claim 8, wherein the register code further comprises an intermediate code with at least one character, wherein the intermediate code is arranged between the initial code and the ending code.

11. The method of claim 10, wherein the initial code, the intermediate code and the combination unit are grouped as a series of register codes, wherein the combination unit is arranged between the initial code and the intermediate code.

12. The method of claim 11, wherein the combination unit is arranged between the intermediate code and the ending code.

13. A method of verifying irregular password, comprising the following steps:
(1) Verifying an input with at least one combination unit whether including at least a register code by examination of an operation system, wherein the combination unit comprises at least a random character which is a text, a number, or a symbol;
(2) Verifying the register code whether exists within the input; if the register code exists, the input is authenticated as one series of valid password; whereas, if the register code does not exist, the input is authenticated as one series of invalid password.

14. The method of claim 13, wherein the step (2) further comprises the step of verifying whether a cancel code exists behind the end of the register code closest to the end of the input, if the register code exist within the input; if the cancel code exists within the input, the input is authenticated as one series of invalid password by the examination of the operation system; whereas, if the cancel code does not exist within their input, the input is authenticated as one series of valid password by the examination of operation system.

15. A method of verifying irregular password, comprising the following steps:
(1) Verifying an input with at least one combination unit whether including at least one series of register codes by examination of an operation system, wherein the series of register codes comprises at least an initial code and an ending code, and wherein the combination unit comprises at least one random character which either is a text, a number, a symbol or one combination grouped by various characters;
(2) Verifying whether the ending code exists within the input if the initial code exists within the input; whereas, the input is authenticated as an invalid password if the initial code does not exist within the input;
(3) Authenticating the input as a series of valid password if the ending code exists within the input by the examination of the operation system; whereas, the input is authenticated as a series of invalid password if the ending code does not exist within the input.

16. The method of claim 15, wherein further verifying the series of register code in the input whether a cancel code exists behind the end of the series of register codes closest to the end of the input, if the series of register codes are within the input; if the cancel code exists within the input, the input is authenticated as a series of invalid password by the examination of the operation system; whereas, if the cancel code does not exist within the input, the input is authenticated as a series of valid password, wherein the cancel code does not exist within the series of register codes.

17. The method of claim 15, wherein the series of register codes further comprises an intermediate code which is arranged between the initial code and the ending code; in the step (2), if the initial code exists within the input, continuously verifying whether an intermediate code exists within the input by the examination of the operation system; if the intermediate code exists within the input, continuously verifying whether the ending code exists in the input; if the intermediate code does not exist within the input, the input is authenticated as a series of invalid password by the examination of the operation system.

18. The method of claim 17, wherein if the series of register codes exist within the input, continuously verifying whether a cancel code exists behind the end of the series of register codes closest to the end of input; if the cancel code exists within the input, the input is authenticated as a series of invalid password; whereas, if the cancel code does not exist within the input, the input is authenticated as a series of valid password, wherein the cancel code does not exist within the series of register codes.
